(19) United States
(12) Patent Application Publication
(10) Pub. No.: US 2021/0088140 A1
(43) Pub. Date: Mar. 25, 2021

(54) SEALING DEVICE AND MACHINE USING SAME

(71) Applicant: TRIPLE WIN TECHNOLOGY(SHENZHEN) CO.LTD., Shenzhen (CN)

(72) Inventor: Zheng-Zhong ZHANG, Shenzhen (CN)

(21) Appl. No.: 16/940,639

(22) Filed: Jul. 28, 2020

(30) Foreign Application Priority Data
Sep. 20, 2019 (CN) 201910895317.9

(51) Int. Cl. F16J 15/10; F16J 15/06

(52) U.S. Cl. CPC F16J 15/104; F16J 15/102; F16J 15/062

(57) ABSTRACT

A sealing device able to contain corrosive liquids includes a base body and a sealing door covering the base body. The base body defines a receiving chamber which defines an opening. The sealing door carries a protrusion and a seal ring. The protrusion corresponds in position and size to the opening to seal the receiving chamber. The protrusion is corrosion resistant and it is the protrusion which experiences sputtering and sloshing of the liquid and not the seal ring. The seal ring is sleeved on the protrusion to seal the base body and the sealing door. The present disclosure further provides a machine including the sealing device.

### FIELD

The subject matter herein generally relates to a sealing device and a machine using the sealing device.

### BACKGROUND

A sealing device is usually used in a machine which contains corrosive liquid used during operation (e.g. a cleaning machine) for sealing a chamber in which corrosive liquid, such as cleaning agent, is received. However, the corrosive liquid will corrode the sealing device after a prolonged used.

### BRIEF DESCRIPTION OF THE DRAWINGS

Implementations of the present technology will now be described, by way of embodiment, with reference to the attached figures.

FIG. 1 is a schematic view of an embodiment of a sealing device.

FIG. 2 is a view from the right of a base body of the sealing device of FIG. 1.

FIG. 3 is a view from the left of a sealing door of the sealing device of FIG. 1.

FIG. 4 is a schematic view of an embodiment of a machine using the sealing device.

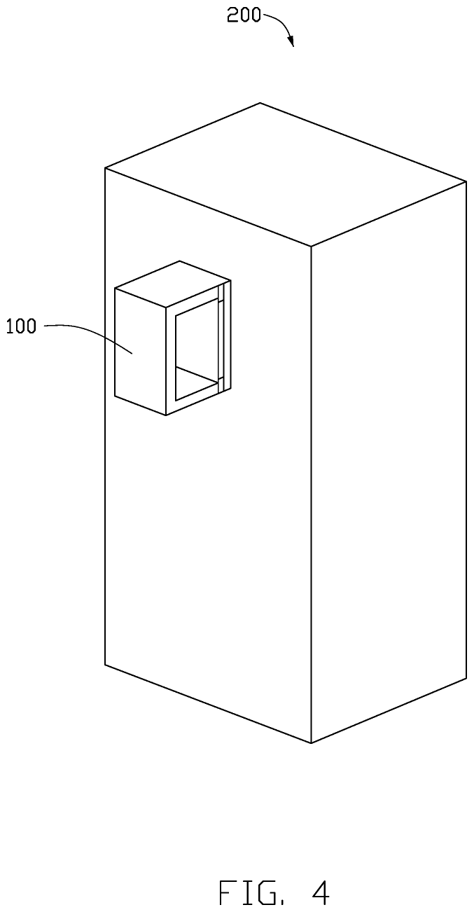

FIG. 5 is a schematic view of another embodiment of a sealing device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

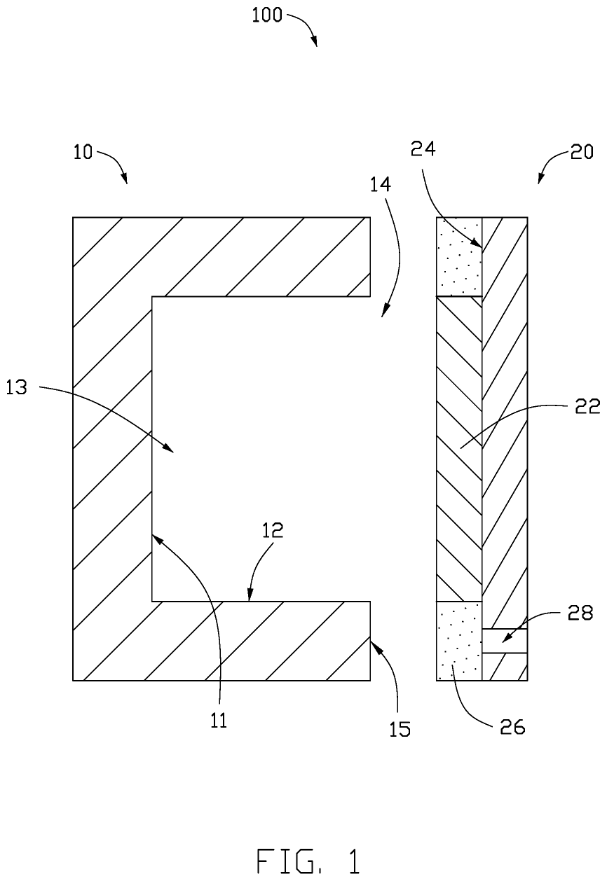

FIG. 1 illustrates an embodiment of a sealing device 100. The sealing device 100 includes a base body 10 and a sealing door 20. The base body 10 includes a bottom wall 11 and a side wall 12. The side wall 12 is arranged on the periphery of the bottom wall 11 to form a receiving chamber 13. The receiving chamber 13 defines an opening 14. The sealing door 20 covers the opening 14 to seal the receiving chamber 13.

The base body 10 is corrosion resistant. For example, the base body 10 is made of corrosion resistant material, or the bottom wall 11 and the side wall 12 of the base body 10 are coated with a corrosion resistant coating. The receiving chamber 13 can be other non-limited shape according to actual needs. In one embodiment, the receiving chamber 13 is substantially rectangular.

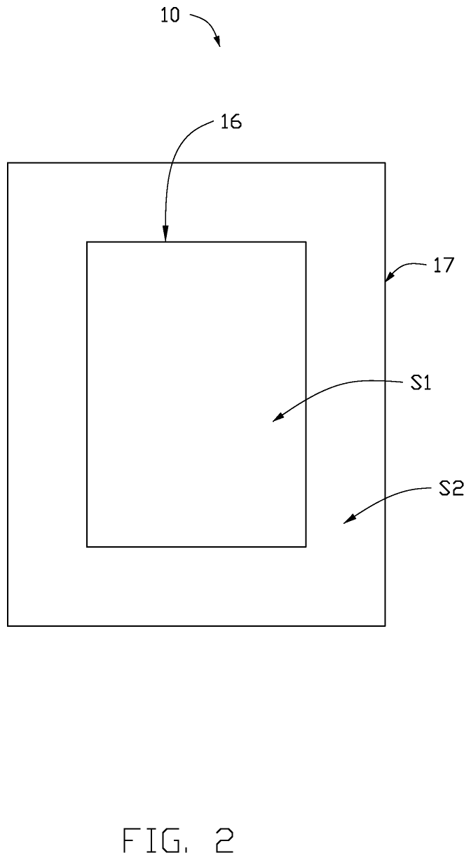

FIG. 2 illustrates that the base body 10 includes a first surface 15. The opening 14 is defined on the first surface 15. The first surface 15 includes an inner edge 16 and an outer edge 17 opposite to the inner edge 16. The inner edge 16 encloses the opening 14, and the outer edge 17 surrounds the inner edge 16. An area surrounded by the inner edge is recorded as a first area S1, that is, the area of the opening 14 is recorded as a first area S1. An area surrounded by the outer edge 17 is recorded as a second area S2. The second area S2 is greater in size than the first area S1.

The sealing door 20 is substantially rectangular. The sealing door 20 includes a second surface 24. The second surface 24 is adjacent to the opening 14, that is, the second surface 24 covers the first surface 15 of the base body 10, thereby sealing the receiving chamber 13.

The sealing door 20 carries a protrusion 22. The protrusion 22 is arranged on the second surface 24, and corresponds in position and size to the opening 14. A thickness of the protrusion 22 along a direction perpendicular to the second surface 24 can be adjusted according to actual needs.

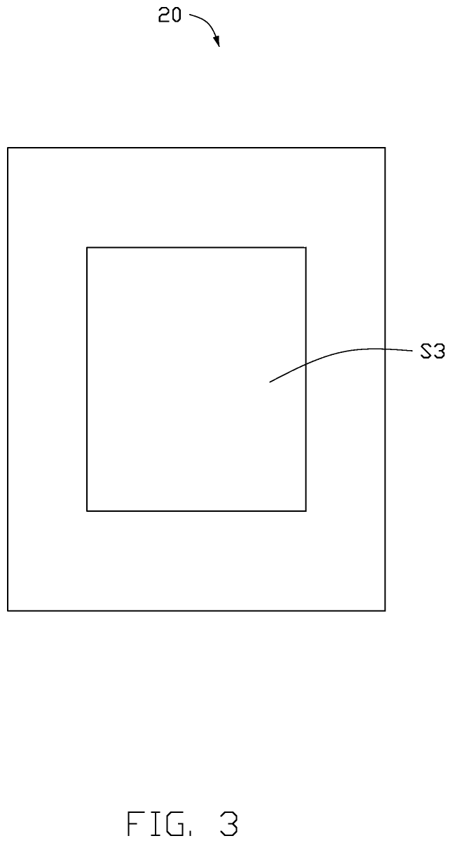

FIG. 3 illustrates that the size of the protrusion 22 is greater than or equal to the size of the opening 14. That is, the protrusion 22 completely covers the opening 14. An area of a surface of the protrusion 22 adjacent to the opening 14 is recorded as a third area S3. The third area S3 is greater than or equal in size to the first area but less in size than the second area S2.

The protrusion 22 seals the opening 14. The sealing door 20 further carries a seal ring 26. The seal ring 26 is arranged on the second surface 24 of the sealing door 20 and is sleeved on the protrusion 22. The seal ring 26 is configured to seal the base body 10 and the sealing door 20. The seal ring 26 is elastic. Material of the seal ring 26 can be polyurethane PU elastomer or epoxy resin AB gel. The seal ring 26 is configured to seal the receiving chamber 13. A thickness of the seal ring 26 is substantially the same as a thickness of the protrusion 22. When the thickness of the seal ring 26 is greater than the thickness of the protrusion 22, corrosive liquid received in the receiving chamber 13 will sputter on the seal ring 26, thus the seal ring 26 is easily corroded. When the thickness of the seal ring 26 is less than the thickness of the protrusion 22, a sealing effect of the sealing door 20 is reduced. The protrusion 22 is corrosion resistant. During use, any sputtering of corrosive liquid in the receiving chamber 13 will only make contact with, and affect, the corrosion resistant protrusion 22, and thus there will be no corrosion of the sealing door 20.

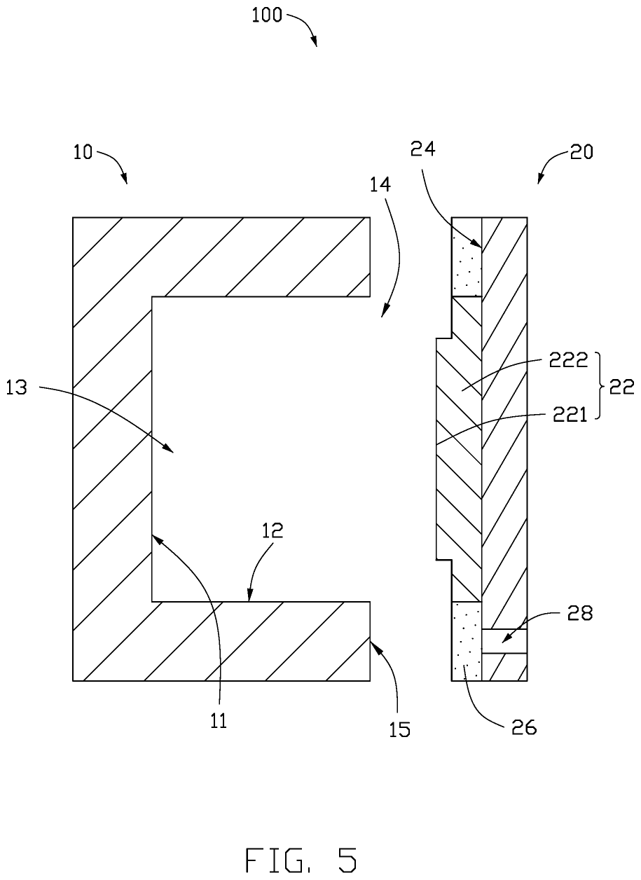

Referring to FIG. 5, in an alternative embodiment, the third area S3 is slightly less than the first area S1, so long as the protrusion 22 can be inserted into the receiving chamber. The protrusion 22 is substantially T-shaped, and includes a first portion 221 and a second portion 222. A size of the first portion 221 is slightly less than a size of the second portion 222. The size of the first portion 221 is slightly less than the size of the opening 14, and the size of the second portion 222 is equal to the size of the opening 14. The seal ring 26 is arranged on the second surface 24 of the sealing door 20 and is sleeved on the second portion 222 of the protrusion 22. The thickness of the seal ring 26 is equal to the thickness of the second portion of the protrusion 22. The first portion 221 of the protrusion 22 protrudes beyond the seal ring 26. When the sealing door 20 is closed on the base body 10, the first portion 221 of the protrusion 22 is received in the receiving chamber 13 and adjoins the sidewall of the receiving chamber 13, the seal ring 26 adjoins the first surface 15. During use of the receiving chamber 13, the liquid in the receiving chamber 13 sputters on the corrosion resistant protrusion 22 and does not directly sputter on the seal ring 26.

The protrusion 22 is made of corrosion resistant material which can be adjusted according to the type of liquid to be contained by the sealing device 100.

In one embodiment, material of the protrusion 22 is hard alloy. The hard alloy is an alloy material made of a hard compound of refractory metals and a bonding metal by a power metallurgy process (e.g. quenching). The hard alloy has excellent properties such as high hardness, wear resistance, high strength, good toughness, heat resistance, and corrosion resistance.

In one embodiment, the protrusion 22 is made of corrosion resistant polymer material, such as polytetrafluoroethylene.

The sealing device 100 further includes a connecting element (not shown). The connecting element connects the base body 10 and the sealing door 20. The connecting element connects the sealing door 20 to the base body 10 to support the sealing door 20 in place and to facilitate the closing of the sealing door 20 on the base body 10.

The sealing door 20 defines a hole 28 on the second surface 24. The hole 28 is for user to hold the cleaning door 20. A depth of the hole can be adjusted according to actual needs. The hole 28 cannot pass through the seal ring 26. FIG. 1 illustrates that the hole 28 passes through the sealing door 20.

In an alternative embodiment, other elements can be arranged on the sealing door 20 to replace the hole 28, such as handle, pull ring, etc.

FIG. 5 illustrates an embodiment of a machine 200 including the sealing device 100. The machine 200 can be a cleaning machine, such as an automatic ultrasonic sensor spray cleaning machine.

### Embodiment 1

An automatic ultrasonic sensor spray cleaning machine includes a sealing device 100. The sealing device 100 includes the base body 10 and the sealing door 20 arranged on the base body 10. The sealing door 20 carries the protrusion 22 and the seal ring 26 sleeved on the protrusion 22. The size of the protrusion 22 is slightly greater than the size of the opening 14, and the thickness of the seal ring 26 is the same as the thickness of the protrusion 22.

### Comparative Embodiment 1

The sealing device of the comparative embodiment 1 is similar to the sealing device of the embodiment 1, the difference between comparative embodiment 1 and embodiment 1 is that the sealing door 20 carries the seal ring but not the protrusion 22.

The automatic ultrasonic sensor spray cleaning machines of embodiment 1 and comparative embodiment 1 are put to use cleaning the same object. A daily consumption of solution and an average production yield in 8 months of the automatic ultrasonic sensor spray cleaning machines of embodiment 1 and comparative embodiment 1 are shown in table 1.

TABLE 1

| | daily consumption of solution | average production |
|---|---|---|
| | (L) | yield |
| embodiment 1 | 2.8 | 99.3% |
| comparative | 3.5 | 98.1% |
| embodiment 1 | | |

As table 1 shows, the daily consumption of solution of embodiment 1 is 20% lower than the daily consumption of solution of comparative embodiment 1, the production yield of embodiment 1 is improved compared with that of embodiment 2.

The configuration of the corrosion resistant protrusion 22 on a side of the cleaning door 20 adjacent to the receiving chamber 13 prevents liquid in the receiving chamber 13 from sputtering directly onto the seal ring 26. The seal ring 26 cannot be corroded by the liquid in the receiving chamber 13, thus ensuring effective sealing of the sealing door 20. The consumption of solution is lowered, the production cost is lowered. Impurities caused by the corrosion of the seal ring are decreased, the products cleaned by the cleaning machine are not contaminated by the impurities, thus the quality of the products is improved, the productivity effect is improved.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A sealing device comprising:
a base body defining a receiving chamber, the receiving chamber defining an opening; and
a sealing door covering the base body, the sealing door comprising a protrusion and a seal ring;
wherein the protrusion corresponds in a position and a size to the opening, the protrusion seals the receiving chamber, the seal ring is sleeved on the protrusion to seal the base body and the sealing door, the protrusion is corrosion resistant.

2. The sealing device of claim 1, wherein material of the protrusion is one or more selected from the group consisting of hard alloy and polymer material.

3. The sealing device of claim 2, wherein the hard alloy is treated by a quenching process.

4. The sealing device of claim 1, wherein the seal ring is elastic.

5. The sealing device of claim 4, wherein material of the seal ring is one or more selected from the group consisting of polyurethane PU elastomer and epoxy resin AB gel.

6. The sealing device of claim 1, wherein the base body comprises a first surface on which the opening is defined, the first surface comprises an inner edge enclosing the opening and an outer edge surrounding the inner edge, a size of the protrusion is greater than a size of an area surrounded by the inner edge and is less than a size of an area surrounded by the outer edge, a thickness of the seal ring is the same as a thickness of the protrusion.

7. The sealing device of claim 1, wherein the base body comprises a first surface on which the opening is defined, the first surface comprises an inner edge enclosing the opening and an outer edge surrounding the inner edge, a size of at least a part of the protrusion adjacent to the opening is less than a size of an area surrounded by the inner edge.

8. The sealing device of claim 7, wherein a thickness of the seal ring is less than a thickness of the protrusion.

9. The sealing device of claim 1, wherein the sealing door comprises a second surface adjacent to the opening, the sealing door defines a hole on the second surface.

10. A machine comprising a sealing device, the sealing device comprising:
a base body defining a receiving chamber, the receiving chamber defining an opening; and
a sealing door covering the base body, the sealing door carrying a protrusion and a seal ring;
wherein the protrusion corresponds in position and size to the opening to seal the receiving chamber, the seal ring is sleeved on the protrusion to seal the base body and the sealing door, the protrusion is corrosion resistant.

11. The machine of claim 10, wherein material of the protrusion is one or more selected from the group consisting of hard alloy and polymer material.

12. The machine of claim 11, wherein the hard alloy is treated by a quenching process.

13. The machine of claim 10, wherein the seal ring is elastic.

14. The machine of claim 13, wherein material of the seal ring is one or more selected from the group consisting of polyurethane PU elastomer and epoxy resin AB gel.

15. The machine of claim 10, wherein the base body comprises a first surface on which the opening is defined, the first surface comprises an inner edge enclosing the opening and an outer edge surrounding the inner edge, a size of the protrusion is greater than a size of an area surrounded by the inner edge and is less than a size of an area surrounded by the outer edge, a thickness of the seal ring is the same as a thickness of the protrusion.

16. The machine of claim 10, wherein the base body comprises a first surface on which the opening is defined, the first surface comprises an inner edge enclosing the opening and an outer edge surrounding the inner edge, a size of at least a part of the protrusion adjacent to the opening is less than a size of an area surrounded by the inner edge.

17. The machine of claim 16, wherein a thickness of the seal ring is less than a thickness of the protrusion.

18. The machine of claim 10, wherein the sealing door comprises a second surface adjacent to the opening, the sealing door defines a hole on the second surface.
